(19) United States
(12) Patent Application Publication
(10) Pub. No.: US 2011/0270910 A1
(43) Pub. Date: Nov. 3, 2011

(54) Dynamic Work Queue For Applications

(75) Inventors: Gregory Ray Floyd, McDonough, GA (US); Eric A. Morris, Acworth, GA (US)

(73) Assignee: Southern Company Services, Atlanta, GA (US)

(21) Appl. No.: 12/771,251

(22) Filed: Apr. 30, 2010

(51) Int. Cl. G06F 15/16

(52) U.S. Cl. 709/203

(57) ABSTRACT

Disclosed are various embodiments for a dynamic work queue for applications. A message queue is included in a data store accessible to one or more computing devices. One or more network pages are generated in the one or more computing devices indicating which ones of multiple services are configured to obtain and process messages for an application from the queue. Each of the services is executed on a respective one of multiple servers. A request is obtained from a client to configure one or more of the services to obtain and process messages for the application from the queue. The one or more of the services are configured to obtain and process messages for the application from the queue in response to the request.

### BACKGROUND

Computer-based applications may perform complex tasks that are resource intensive and/or time intensive. Instead of having an application wait for a complex task to be completed and stall other tasks, it may be desirable to offload the complex task for processing by other computer systems. Various commercially available middleware tools such as IBM® WebSphere® MQ and Microsoft® Message Queuing (MSMQ) enable message passing between different systems. However, such tools have been created with software developers in mind, not application managers. Such tools may require manual coding of trigger services and extensive configuration to enable different applications to submit and obtain work from a queue. In addition, such tools may require administrative access to each system for configuration.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a drawing of an example of a user interface rendered by a client in the networked environment of FIG. 1 according to various embodiments of the present disclosure.

FIG. 3 is a flowchart illustrating one example of functionality implemented as portions of a queue service executed in a computing device in the networked environment of FIG. 1 according to various embodiments of the present disclosure.

FIG. 4 is a flowchart illustrating one example of functionality implemented as portions of a queue management application executed in a computing device in the networked environment of FIG. 1 according to various embodiments of the present disclosure.

FIG. 5 is a schematic block diagram that provides one example illustration of a computing device employed in the networked environment of FIG. 1 according to various embodiments of the present disclosure.

### DETAILED DESCRIPTION

The present disclosure relates to providing a dynamic work queue for applications. According to embodiments of the present disclosure, a message queue may be maintained in a data store. Clients may be configured to submit messages to the queue for further processing of tasks. Instances of a service may be configured to obtain messages from the queue and implement the task processing. The service may be a standardized program deployed to a number of servers. Various applications may be deployed to one or more of the servers, and the deployment of the applications to the servers may be managed dynamically. The applications may be configured to communicate with the service by way of a generic interface for simplicity. In the following discussion, a general description of the system and its components is provided, followed by a discussion of the operation of the same.

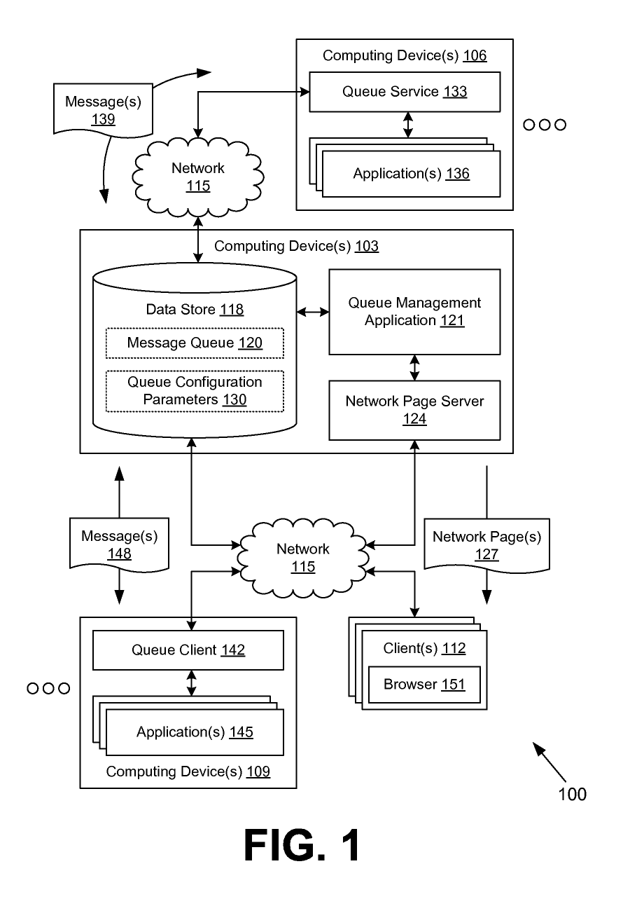

With reference to FIG. 1, shown is a networked environment 100 according to various embodiments. The networked environment 100 includes one or more computing devices 103, one or more computing devices 106, one or more computing devices 109, and one or more clients 112 in data communication by way of a network 115. The network 115 includes, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. A plurality of computing devices 103 together may comprise, for example, a cloud computing resource, a grid computing resource, and/or any other distributed computing arrangement. Such computing devices 103 may be located in a single installation or may be dispersed among many different geographical locations. In one embodiment, the computing device 103 represents a virtualized computer system executing on one or more physical computing systems. For purposes of convenience, the computing device 103 is referred to herein in the singular. Even though the computing device 103 is referred to in the singular, it is understood that a plurality of computing devices 103 may be employed in the various arrangements as described above.

Various applications and/or other functionality may be executed in the computing device 103 according to various embodiments. Also, various data is stored in a data store 118 that is accessible to the computing device 103. The data store 118 may be representative of a plurality of data stores as can be appreciated. In one embodiment, the data store 118 corresponds to a commercially available relational database management system (RDBMS) such as, for example, Oracle® or some other RDBMS. The data stored in the data store 118, for example, includes a message queue 120 and is associated with the operation of the various applications and/or functional entities described below.

The components executed on the computing device 103, for example, include a queue management application 121, a network page server 124, and other applications, services, processes, systems, engines, or functionality not discussed in detail herein. The queue management application 121 is executed to configure applications to use the message queue 120 and to manage tasks that are currently queued for processing or are currently being processed. The network page server 124 is executed to process network pages 127, such as web pages, that are generated by the queue management application 121 and to send the network pages 127 to the client 112. The network page server 124 may also be configured to receive data from the client 112 and to submit the data to the queue management application 121. In various embodiments, the network page server 124 may comprise a commercially available hypertext transfer protocol (HTTP) server, such as Apache® HTTP Server, Microsoft® Internet Information Services (IIS), or some other server.

The data stored in the data store 118 includes, for example, the message queue 120, queue configuration parameters 130, and potentially other data. The message queue 120 implements a dynamic work queue where tasks are enqueued for processing. To this end, the message queue 120 may implement a first-in-first-out (FIFO) queue or some other type of queue. In addition, in some embodiments, the message queue 120 may store results generated from processing the tasks and/or status information related to the tasks. The message queue 120 may include various locks, mutexes, semaphores, etc., to coordinate access to the message queue 120.

The queue configuration parameters 130 store various parameters related to the message queue 120. As non-limiting examples, the queue configuration parameters 130 may configure deployment of applications on servers that are used to process queued tasks, load balancing of tasks, and so on. The queue configuration parameters 130 may also include parameters regarding the processing of tasks including, for example, one or more time-limit parameters for task processing.

Each of the computing devices 106 may comprise, for example, a server computer or any other system providing computing capability. Alternatively, a plurality of computing devices 106 may be employed that are arranged, for example, in one or more server banks or computer banks or other arrangements. A plurality of computing devices 106 together may comprise, for example, a cloud computing resource, a grid computing resource, and/or any other distributed computing arrangement. Such computing devices 106 may be located in a single installation or may be dispersed among many different geographical locations. In one embodiment, the computing device 106 represents a virtualized computer system executing on one or more physical computing systems. For purposes of convenience, the computing device 106 is referred to herein in the singular. Even though the computing device 106 is referred to in the singular, it is understood that a plurality of computing devices 106 may be employed in the various arrangements as described above.

Various applications and/or other functionality may be executed in the computing device 106 according to various embodiments. The components executed on the computing device 106, for example, include a queue service 133, one or more applications 136, and other applications, services, processes, systems, engines, or functionality not discussed in detail herein. The queue service 133 is executed to obtain messages 139 from the message queue 120. The messages 139 correspond to tasks to be performed. The messages 139 are passed through, for example, a common or generic interface, to one or more of the applications 136. The applications 136 are executed to perform the processing work associated with the messages 139. In various embodiments, the applications 136 may be configured to perform business logic and/or other tasks that may require off-line processing. In some cases, the applications 136 may produce a result, which may be submitted to the queue service 133 and returned as another message 139.

Each of the computing devices 109 may comprise, for example, a server computer or any other system providing computing capability. Alternatively, a plurality of computing devices 109 may be employed that are arranged, for example, in one or more server banks or computer banks or other arrangements. A plurality of computing devices 109 together may comprise, for example, a cloud computing resource, a grid computing resource, and/or any other distributed computing arrangement. Such computing devices 109 may be located in a single installation or may be dispersed among many different geographical locations. In one embodiment, the computing device 109 represents a virtualized computer system executing on one or more physical computing systems. For purposes of convenience, the computing device 109 is referred to herein in the singular. Even though the computing device 109 is referred to in the singular, it is understood that a plurality of computing devices 109 may be employed in the various arrangements as described above.

Various applications and/or other functionality may be executed in the computing device 109 according to various embodiments. The components executed on the computing device 109, for example, include a queue client 142, one or more applications 145, and other applications, services, processes, systems, engines, or functionality not discussed in detail herein. The queue client 142 is executed to place messages 148 into the message queue 120 on behalf of a corresponding application 145. The messages 148 represent work to be performed for the application 145. The queue client 142 may also be executed to obtain results from the message queue 120 in the form of messages 148 and to pass those messages 148 onto the corresponding application 145. In various embodiments, one or more of the applications 136 may perform work for one of the applications 145. In other embodiments, applications 136 may perform work for multiple applications 145.

The client 112 is representative of a plurality of client devices that may be coupled to the network 115. The client 112 may comprise, for example, a processor-based system such as a computer system. Such a computer system may be embodied in the form of a desktop computer, a laptop computer, a personal digital assistant, a cellular telephone, set-top box, music players, web pads, tablet computer systems, or other devices with like capability.

The client 112 may be configured to execute various applications such as a browser 151 and/or other applications. The browser 151 may be executed in a client 112, for example, to access and render network pages, such as web pages, or other network content served up by the computing device 103 and/or other servers. The client 112 may be configured to execute applications beyond browser 151 such as, for example, email applications, instant message applications, and/or other applications.

Next, a general description of the operation of the various components of the networked environment 100 is provided. To begin, various applications 145 are developed using an application programming interface (API) supported by the queue client 142. The applications 145 may have discrete tasks that are desirable to be offloaded to other computing systems for processing. The applications 145 may comprise, for example, interactive online applications where asynchronous processing is preferable. Further, the computing devices 109 hosting the respective applications 145 may have limited capacity, making it desirable for resource-intensive tasks to be performed by other systems.

The applications 145 are configured to send the tasks to the queue client 142. The applications 145 may, for example, make a procedure call to the queue client 142. The procedure call may include a plurality of parameters to define the work that is to be performed. In one embodiment, the applications 145 may create a data object containing various data that describes the work. Such a data object may be passed to the queue client 142 through a procedure call, inter-process communication, web service, etc. The queue client 142 is configured to generate a message 148 embodying the work and to store the message 148 in the message queue 120.

The queue management application 121 enables the initial configuration of the message queue 120 and the various other systems. After a queue service 133 is installed on a computing device 106, the queue management application 121 may configure the queue service 133 to obtain and process messages 139 from the message queue 120 for one or more applications 136. The applications 136 are developed according to an API used by the queue service 133 so that the queue service 133 may submit the work described by the message 139 to the applications 136 for processing.

In one embodiment, the queue management application 121 may facilitate the deployment and/or uploading of the applications 136 to computing devices 106. As a non-limiting example, the queue management application 121 may provide a network page 127 interface for a user at a client 112 to upload code implementing an application 136 and to select to which computing device(s) 106 the application 136 is to be deployed. To this end, the network page 127 may show a listing of various computing devices 106 that are selectable for deployment of the application 136.

The queue management application 121 may also facilitate discovery and/or configuration of queue services 133 executing on computing devices 106. In one embodiment, once a queue service 133 has been installed on a computing device 106, a user may log into the queue management application 121 by way of a network page 127 and register the instance of the queue service 133 with the queue management application 121. The registration of the queue service 133 may be recorded, for example, in the queue configuration parameters 130. Afterward, applications 136 may be deployed to the computing device 106 executing the instance of the queue service 133. Such deployment may involve manual installation or automated deployment through the queue management application 121.

A queue service 133 instance is thereby configured to know to which applications 136 it can deliver work. Accordingly, in one embodiment, the queue service 133 instance may poll the message queue 120 to determine when a message 139 that may be handled by the instance is available. In another embodiment, another service may monitor the message queue 120 and notify the respective instance of the queue service 133 when a message 139 is available. Although the work is described in terms of messages 139 and 148, it is understood that the form of the messages 139 and 148 may be identical in some embodiments. Additionally, a result message 139 or 148 may differ in form from a message 139 or 148 describing work that has yet to be performed.

When a queue service 133 instance obtains a message 139 from the message queue 120, the processing of the message 139 may thereby be reserved for the specific instance of the queue service 133. In other embodiments, multiple instances of the queue service 133 may be configured to obtain and process a single message 139. The queue service 133 instance then submits the work described by the message 139 to a corresponding application 136. Such communication may be synchronous or asynchronous. Multiple types of applications 136 and multiple instances of a same type of application 136 may be executing concurrently on a computing device 106.

An application 136 may have a time limit configured in the queue configuration parameters 130 for the processing of the task. In some cases, processing of a task by the application 136 may fail, which may result in an exception being generated. However, the computing device 106 may be configured so that the failure of an application 136 in processing a task does not affect the operation of other applications 136 on the same computing device 106 or on other computing devices 106.

When the application 136 has completed processing of the work described by the message 139, the application 136 may return the result of the processing to the queue service 133. Accordingly, the queue service 133 may submit another message 139 embodying the result of the processing of the original message 139 to the message queue 120. In one embodiment, the queue client 142 that originated the message 148 may poll the message queue 120 for a response message 148 to determine when the processing has completed. In another embodiment, the queue service 133 or some other service may be configured to notify the originating queue client 142 directly that the processing has completed and/or pass a response message 148 to the originating queue client 142.

In addition to configuration of instances of the queue service 133 and applications 136, the queue management application 121 may also generate user interfaces displaying the status associated with various components of the system, such as tasks, applications 136, queue service 133 instances, and so on. Statuses for tasks may include, for example, awaiting processing, currently processing, processing completed, processing failed, and/or other statuses. The queue management application 121 may also enable the management of specific tasks that are, for example, currently queued in the message queue 120 or being executed by an application 136. More discussion of the various features of the queue management application 121 is provided in connection with the next figure.

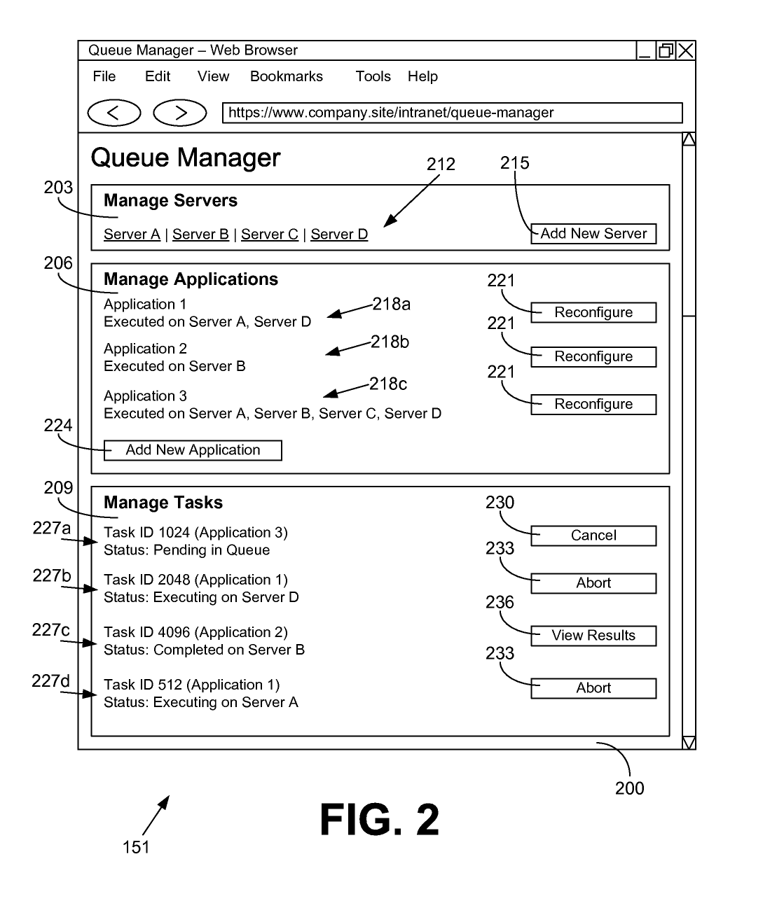

Turning now to FIG. 2, shown is one example of a user interface rendered by a browser 151 executing in a client 112 (FIG. 1) in the networked environment 100 (FIG. 1). Specifically, one non-limiting example of a network page 200 generated by the queue management application 121 (FIG. 1) for managing the message queue 120 (FIG. 1) is illustrated. In other embodiments, the various components included in the network page 200 may be configured by way of multiple other network pages 200. The network page 200 as shown includes three display regions: a server configuration region 203, an application configuration region 206, and a task configuration region 209. In another embodiment, each of these display regions may be included in a separate network page 200.

The server configuration region 203 provides components for configuring servers that correspond to computing devices 106 (FIG. 1) on which instances of the queue service 133 (FIG. 1) are executed. A list of servers 212 may be provided to show which servers have already been configured. In one embodiment, each server in the list of servers 212 may have a corresponding link, for example, to another network page 200, pop-up window, pop-over window, etc., providing more information and configuration options for the respective server. In this example, four servers are currently configured: “Server A,” “Server B,” “Server C,” and “Server D.” Once a server is configured, applications 136 (FIG. 1) may be deployed to it.

The server configuration region 203 may also include an add server component 215 to facilitate registering a server having an instance of the queue service 133 with the queue management application 121. The add server component 215 may trigger another network page 200 or a dialog window to be loaded by the browser 151 in order to obtain further information about the additional server. Such information may include, but is not limited to, internet protocol (IP) address of the server, system resources, number of current requests that may be processed, time interval between polling the message queue 120, and other information. In other embodiments, servers may be arranged in groups (e.g., server banks) concurrently executing multiple instances of the queue service 133. Such groups may facilitate ease of deployment of applications 136 to multiple computing devices 106 and queue service 133 instances.

The network page 200 may also include an application configuration region 206 used to configure applications 136 and/or deploy the applications 136 to servers or groups of servers. Three application listings 218a, 218b, and 218c are shown in this non-limiting example. Application listing 218a shows that “Application 1” is deployed on “Server A” and “Server D.” Application listing 218b shows that “Application 2” is deployed on “Server B.” Application listing 218c shows that “Application 3” is deployed on “Server A,” “Server B,” “Server C,” and “Server D.” Thus, it can be seen that different applications 136 may be executed on a same server, yet not all servers necessarily execute all of the applications 136.

Each of the application listings 218 may have a reconfigure component 221 used to launch a reconfiguration of the settings for the particular application 136. The reconfigure component 221 may trigger another network page 200 or a dialog window to be loaded by the browser 151 in order to present options to the user. As a non-limiting example, the various servers to which the application 136 is deployed may be reconfigured.

The application configuration region 206 may also include an add application component 224 for adding a new application 136. The add application component 224 may trigger another network page 200 or a dialog window to be loaded by the browser 151 in order to obtain further information about the new application 136. In particular, a user interface may be provided for uploading the application 136 through the browser 151. Interface components may be provided for the user to designate certain servers or groups of servers for deployment of the application 136. The queue management application 121 may then be configured to deploy the application 136 to the designated servers.

The network page 200 may also include a task configuration region 209 used to manage tasks, for example, that are pending in the message queue 120, that are being processed by applications 136, that have been completed, or that have some other status. Four task listings 227a, 227b, 227c, and 227d are shown in this non-limiting example. Each of the task listings 227 may show, for example, an identifier associated with the task, an application 136 configured to process the task, a current status associated with the task, including any servers assigned to process the task, time and resources consumed by the task, estimated time until completion of the task, and/or other information. One or more actions may be initiated regarding each of the tasks as desired.

The task listing 227a describes a task that is pending in the message queue 120. In other words, a message 148 describing the task has been placed in the message queue 120 by a queue client 142, but the task has not been assigned to a queue service 133 or begun processing. Accompanying the task listing 227a is a cancel component 230 for initiating a cancellation of the task. When a user selects the cancel component 230, a request to cancel the task is submitted to the queue management application 121. Subsequently, the task may be canceled and removed from the message queue 120. In some embodiments, the queue client 142 may be sent a notification message 148 regarding the cancellation.

The task listings 227b and 227d describe tasks that are currently being executed by applications 136. In this non-limiting example, task listings 227b and 227d relate to tasks executed by the same application 136 (“Application 1”) but on different servers (“Server D” and “Server A”). Accompanying the task listings 227b and 227d are abort components 233 for aborting the processing of the respective tasks. When a user selects the abort component 233, a request to abort the task is submitted to the queue management application 121. Subsequently, execution of the task by the respective application 136 instance on one or more computing devices 106 may be aborted. In some cases, the stopping of the task may be successful, while in other cases, the stopping of the task may be unsuccessful. In some embodiments, the queue client 142 may be sent a notification message 148 regarding whether the task has been successfully aborted.

The task listing 227c describes a task for which processing has been completed by the application 136. In such a case, the status or result of the processing may be reported in a message 139 back to the message queue 120, the queue client 142, and/or other recipients. Accompanying the task listing 227c is a view result component 236 for viewing the result or status of the task. When a user selects the view result component 236, the results may be retrieved from the server and rendered in another network page 200, in a dialog window, or at some other location. In one embodiment, the results and other data may be downloaded from the network page server 124 (FIG. 1) asynchronously in advance using Ajax or another technology.

Although the add server component 215, the reconfigure components 221, the add application component 224, the cancel component 230, the abort components 233, and the view result component 236 are depicted in FIG. 2 as buttons, it is understood these components may comprise any type of user interface components such as, for example, links, selectable images, checkboxes, radio buttons, etc. Moreover, in other embodiments, the user interface for the queue management application 121 may be rendered by a thin or thick client application executing on the client 112 other than the browser 151.

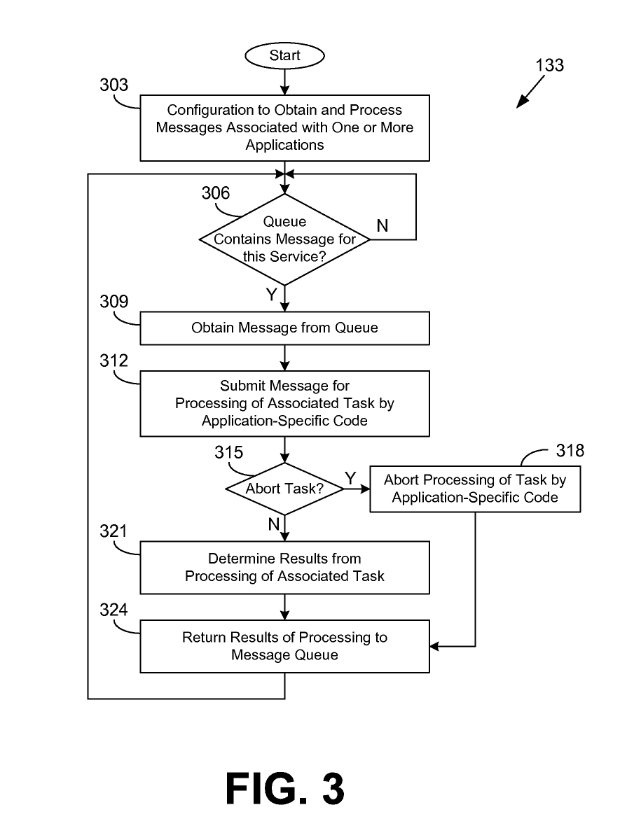

Referring next to FIG. 3, shown is a flowchart that provides one example of the operation of a portion of the queue service 133 according to various embodiments. It is understood that the flowchart of FIG. 3 provides merely an example of the many different types of functional arrangements that may be employed to implement the operation of the portion of the queue service 133 as described herein. As an alternative, the flowchart of FIG. 3 may be viewed as depicting an example of steps of a method implemented in the computing device 106 (FIG. 1) according to one or more embodiments.

Beginning with box 303, the queue service 133 is configured to obtain and process messages 139 (FIG. 1) associated with one or more applications 136 (FIG. 1). In one embodiment, the applications 136 are deployed on the respective computing device 106, and then an action is taken on the computing device 106 to register the applications 136 with the queue service 133. In another embodiment, the queue management application 121 is used to deploy applications 136 to designated computing devices 106. In any case, the queue service 133 is thereby configured to retrieve certain ones of the messages 139 (FIG. 1) in the message queue 120 (FIG. 1) and to deliver the messages 139 to the respective applications 136 for further processing.

In box 306, the queue service 133 determines whether the message queue 120 contains a message 139 that can be processed by this queue service 133 instance. In one embodiment, the queue service 133 may poll the message queue 120 to look for messages 139 that have arrived and are awaiting processing. In other embodiments, events to notify the queue service 133 may be generated by another service. If there are no messages 139 that may be processed by this instance of the queue service 133, the queue service 133 may return to box 306 and check again.

If there is a message 139 to be processed, the queue service 133 obtains the message 139 from the message queue 120 in box 309. In one embodiment, where the data store 118 (FIG. 1) comprises an RDBMS, obtaining the message 139 from the message queue 120 may involve a structured query language (SQL) select query and/or other SQL queries. Next, in box 312, the queue service 133 submits the message 139 for processing of the associated task by application-specific code embodied by the respective application 136.

While the application 136 is performing the task, the queue service 133 may receive an indication to abort the task, for example, from the queue management application 121. In box 315, the queue service 133 determines whether processing of the task is to be aborted. It may be the case that processing of the task cannot be stopped. If the processing is to be aborted, the queue service 133 moves to box 318 and aborts processing of the task by the application 136. Thereafter, the queue service 133 may return to box 306 and seek another message 139 to process.

If the task is not to be aborted, the processing of the task is completed by the application 136. In box 321, the queue service 133 determines the results from the processing of the task by the application 136. In box 324, the queue service 133 returns the results of the processing to the message queue 120 as a new message 139, which is to be obtained by the originating queue client 142. Thereafter, the queue service 133 may return to box 306 and seek another message 139 to process.

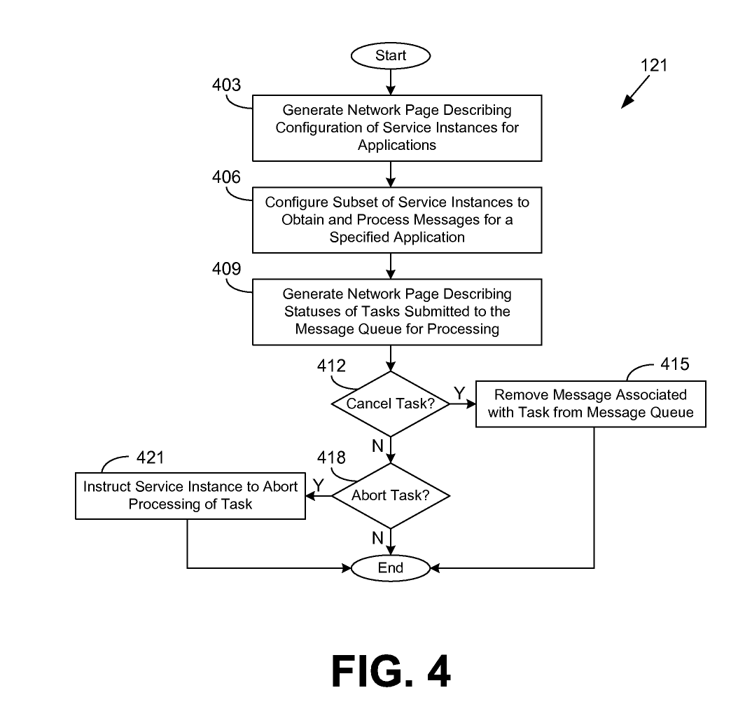

Referring next to FIG. 4, shown is a flowchart that provides one example of the operation of a portion of the queue management application 121 according to various embodiments. It is understood that the flowchart of FIG. 4 provides merely an example of the many different types of functional arrangements that may be employed to implement the operation of the portion of the queue management application 121 as described herein. As an alternative, the flowchart of FIG. 4 may be viewed as depicting an example of steps of a method implemented in the computing device 103 (FIG. 1) according to one or more embodiments.

Beginning with box 403, the queue management application 121 generates a network page 127 (FIG. 1) describing configuration of instances of the queue service 133 (FIG. 1) for applications 136 (FIG. 1). Such a network page 127 may include display regions such as, for example, the server configuration region 203 (FIG. 2), the application configuration region 206 (FIG. 2), and/or other display regions. The network page 127 is sent to the client 112 (FIG. 1) for rendering in the browser 151 (FIG. 1). A user may configure various settings and select various options, and data is uploaded to the queue management application 121. Next, in box 406, the queue management application 121 configures a subset of instances of the queue service 133 to obtain and process messages 139 for a selected application 136.

In box 409, the queue management application 121 generates a network page 127 describing the status of tasks submitted to the message queue 120 (FIG. 1) for processing. Such a network page 127 may include display regions such as, for example, the task configuration region 209 (FIG. 2) and/or other display regions. The network page 127 may then be sent to the client 112 for rendering in the browser 151. The queue management application 121 may then receive one or more instructions from the user.

In box 412, the queue management application 121 determines whether a task is to be canceled. If a task is to be canceled, the queue management application 121 proceeds to box 415 and removes the message 139 (FIG. 1) associated with the task from the message queue 120. Thereafter, the portion of the queue management application 121 ends.

In box 418, if a task is not to be canceled, the queue management application 121 determines whether a task is to be aborted. If a task is to be aborted, the queue management application 121 proceeds to box 421 and instructs the queue service 133 instance to abort processing of the task. Thereafter, the portion of queue management application 121 ends. If a task is not to be aborted, the portion of the queue management application 121 also ends.

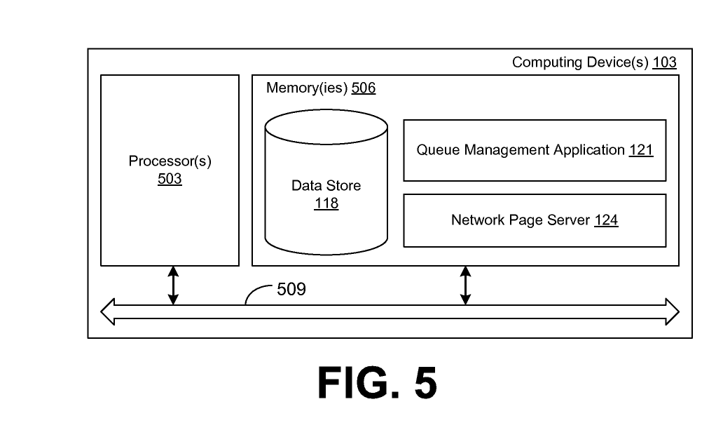

With reference to FIG. 5, shown is a schematic block diagram of the computing device 103 according to an embodiment of the present disclosure. The present disclosure also describes computing devices 106 and 109. It is understood that much of the discussion regarding the structure of the computing device 103 may also apply to the computing devices 106 and 109 (FIG. 1). The computing device 103 includes at least one processor circuit, for example, having a processor 503 and a memory 506, both of which are coupled to a local interface 509. To this end, the computing device 103 may comprise, for example, at least one server computer or like device. The local interface 509 may comprise, for example, a data bus with an accompanying address/control bus or other bus structure as can be appreciated.

Stored in the memory 506 are both data and several components that are executable by the processor 503. In particular, stored in the memory 506 and executable by the processor 503 are the queue management application 121, the network page server 124, and potentially other applications. Also stored in the memory 506 may be a data store 118 and other data. In addition, an operating system may be stored in the memory 506 and executable by the processor 503.

It is understood that there may be other applications that are stored in the memory 506 and are executable by the processors 503 as can be appreciated. Where any component discussed herein is implemented in the form of software, any one of a number of programming languages may be employed such as, for example, C, C++, C#, Objective C, Java, Java Script, Perl, PHP, Visual Basic, Python, Ruby, Delphi, Flash, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and the memory 506 may represent multiple memories 506 that operate in parallel processing circuits, respectively. In such a case, the local interface 509 may be an appropriate network 115 (FIG. 1) that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

Although the queue management application 121, the network page server 124, the queue service 133 (FIG. 1), the queue client 142 (FIG. 1), and the applications 136, 145 (FIG. 1), and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The dynamic work queue described above includes per-application isolation using separate application domains within each physical process. This feature provides a level of fault-tolerance, since unexpected conditions (even memory corruption) within a single application will not affect queue operation for other applications.

At the same time, the dynamic work queue in one embodiment makes efficient use of system resources by using a custom thread pool rather than starting a heavyweight process for each application. Thus, it is safe to abort a thread from the pool since the affected application domain (which might be in an inconsistent state due to the abort) can by unloaded by the engine.

The flowcharts of FIGS. 3 and 4 show the functionality and operation of an implementation of portions of the queue service 133 and the queue management application 121. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts of FIGS. 3 and 4 show a specific order of execution, it is understood that the order of execution may differ from that which is depicted. For example, the order of execution of two or more blocks may be scrambled relative to the order shown. Also, two or more blocks shown in succession in FIGS. 3 and 4 may be executed concurrently or with partial concurrence. Further, in some embodiments, one or more of the blocks shown in FIGS. 3 and 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the queue management application 121, the network page server 124, the queue service 133, the queue client 142, and the applications 136, 145, that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in a computing device, the program comprising:
code that obtains a message from a message queue maintained in a data store on another computing device, the message being associated with one of a plurality of applications, the message being obtained when the program has been configured to obtain and process messages for at least the one of the applications;
code that submits the message for processing for the one of the applications in the computing device, the processing being configured to be implemented by code specific to the one of the applications; and
code that transmits a result message to the message queue, the result message indicating a result of the processing of the message, the result message being directed to a client that originated the message.

2. The computer-readable medium of claim 1, wherein the program further comprises code that configures the program to obtain and process messages for the one of the applications in response to obtaining an instruction from a queue management application.

3. The computer-readable medium of claim 2, wherein the instruction includes the code specific to the one of the applications.

4. The computer-readable medium of claim 1, wherein the code specific to the one of the applications is configured to perform a task associated with the one of the applications.

5. The computer-readable medium of claim 4, wherein the program further comprises code that updates a processing status associated with the task in the data store.

6. The computer-readable medium of claim 4, wherein the program further comprises code that aborts processing of the task in response to obtaining an instruction from a queue management application.

7. The computer-readable medium of claim 1, wherein the code specific to the one of the applications is configured to interface with the program through a generic interface.

8. A system, comprising:
at least one computing device;
a message queue included in a data store accessible to the at least one computing device; and
a queue management application executable in the at least one computing device, the queue management application comprising:
logic that generates at least one network page indicating which ones of a plurality of services are configured to obtain and process messages for an application from the message queue, each of the services being executed on a respective one of a plurality of servers;
logic that obtains a request from a client to configure at least one of the services to obtain and process messages for the application from the message queue; and
logic that configures the at least one of the services to obtain and process messages for the application from the message queue in response to the request.

9. The system of claim 8, wherein the queue management application further comprises:
logic that obtains a subsequent request from the client to configure the least one of the services to stop obtaining and processing messages for the application from the message queue; and
logic that configures the at least one of the services to stop obtaining and processing messages for the application from the message queue in response to the subsequent request.

10. The system of claim 8, wherein the data store comprises a relational database management system.

11. The system of claim 8, wherein each of the respective messages from the message queue specify a corresponding task to be performed for the application.

12. The system of claim 8, wherein at least one of the services is configured to obtain and process messages for another application from the message queue.

13. The system of claim 8, wherein the queue management application further comprises logic that generates at least one network page listing a processing status for each one of a plurality of messages.

14. The system of claim 13, wherein the network page includes a component for aborting the processing of at least one of the messages.

15. The system of claim 13, wherein the network page includes a component for canceling the processing of at least one of the messages.

16. The system of claim 13, wherein each processing status is selected from the group consisting of: awaiting processing, currently processing, processing completed, and processing failed.

17. The system of claim 8, wherein each of the services corresponds to a respective instance of a common service application, and the at least one of the services interfaces with application-specific code to process messages for the application.

18. A method, comprising the steps of:
encoding, in at least one computing device, a network page for rendering by a client, the network page listing a processing status associated with each of a plurality of tasks submitted to a message queue for processing by a plurality of service instances, each of the service instances executed on a corresponding server;
obtaining, in the at least one computing device, a request to cancel a first one of the tasks from the client;
discarding, in the at least one computing device, a message from the message queue in response to the request to cancel, the message being associated with the one of the tasks;
obtaining, in the at least one computing device, a request to abort a second one of the tasks from the client; and
instructing, in the at least one computing device, a respective one of the service instances to abort the second one of the tasks in response to the request to abort.

19. The method of claim 18, wherein each of the tasks is associated with one of a plurality of applications, and each of the service instances is configurable to obtain and process tasks associated with any subset of the applications.

20. The method of claim 19, further comprising the step of configuring a subset of the service instances to obtain and process tasks associated with one of the applications.
